(19) United States
(12) Patent Application Publication
(10) Pub. No.: US 2011/0198915 A1
(43) Pub. Date: Aug. 18, 2011

(54) AUTOMOBILE WHEEL

(75) Inventor: Katsuya Chashiro, Aichi (JP)

(73) Assignee: Central Motor Wheel Co., Ltd., Aichi (JP)

(21) Appl. No.: 13/026,661

(22) Filed: Feb. 14, 2011

(30) Foreign Application Priority Data
Feb. 18, 2010 (JP) 2010-033097

(51) Int. Cl. B60B 3/04

(52) U.S. Cl. 301/63.103

(57) ABSTRACT

Because a front flange portion including an annular front peripheral portion and an annular back peripheral portion is formed along an outer peripheral edge portion of the wheel disc, and because a back surface portion and an opening end portion of a front bead seat portion of a wheel rim are welded to each other over the entire circumference of the wheel but the annular back peripheral portion and the wheel rim are not welded to each other, stress concentration on the front flange portion due to a load generated while the automobile is running can be mitigated. Therefore, an automobile wheel has high durability against a load generated while the automobile is running.

### CROSS-REFERENCE TO PRIOR APPLICATIONS

Priority is claimed to Japanese Patent Application No. 2010-033097, filed on Feb. 18, 2010, which is hereby incorporated by reference in its entirety herein.

### FIELD OF THE INVENTION

The present invention relates to an automobile wheel in which a wheel rim on which a tire is to be mounted and a wheel disc to which an axle is to be coupled are welded to each other for integration.

### BACKGROUND

There are so-called two-piece automobile wheels in which a generally cylindrical wheel rim and a generally disc-like wheel disc are welded to each other. As such two-piece automobile wheels, there are known full-face automobile wheels in which a front flange portion is formed at an outer peripheral edge portion of the wheel disc.

An example of the full-face automobile wheels is proposed in JP-A-Hei 11-042901 (“JP '901”), for example. As shown in FIG. 10, a wheel rim “f” includes a front bead seat portion “g” provided at one opening edge portion and a back flange portion “j” provided at the other opening edge portion. A wheel disc “p” includes a front flange portion “r” provided at an outer peripheral edge portion and folded backward in a curved shape. An opening end portion “h” of the front bead seat portion “g” of the wheel rim “f” and an inner peripheral end portion “v” of the front flange portion “r” of the wheel disc “p” are welded to each other over the entire circumference of the wheel to form a full-face automobile wheel “nm”. The thus configured full-face automobile wheel “m” can secure a large design surface on the wheel disc “p”, advantageously providing high design quality.

In the configuration disclosed in JP '901 described above, the opening end portion “h” of the front bead seat portion “g” of the wheel rim “f” and the inner peripheral end portion “v” of the front flange portion “r” of the wheel disc “p” are welded to each other so that a welded portion “i” joins the wheel rim “f” and the wheel disc “p” to each other. When an automobile equipped with the automobile wheel “in” is running, a load acts on the wheel rim “f” via a tire, and a load acts on the wheel disc “p” via an axle. The front flange portion “r” of the automobile wheel “m” is folded backward in a curved shape and has a generally U-shaped cross-section, and couples the wheel rim “f” and a central portion (portion to be coupled to an axle) of the wheel disc “p”. Therefore, the front flange portion “r” tends to be repeatedly elastically deformed by the load acting on the wheel rim “f” and the load acting on the wheel disc “p”, and tends to be subjected to a stress concentration. Further, because the front flange portion “r” is folded backward through a pressing process or the like, a residual stress may be caused at a curved outermost peripheral edge portion of the front flange portion “r”. The durability of the front flange portion “r” is limited by the residual stress and the stress concentration due to the loads described above.

### SUMMARY OF THE INVENTION

The present invention proposes an automobile wheel that includes a wheel disc provided with a front flange portion folded backward and having improved durability

The present invention provides an automobile wheel including a wheel rim in which a back flange portion is formed at one opening edge portion and a front bead seat portion is formed at the other opening edge portion, and a wheel disc in which a front flange portion is formed at an outer peripheral edge portion, in which the front flange portion of the wheel disc includes an annular front peripheral portion provided on a design surface side and an annular back peripheral portion folded backward from the annular front peripheral portion and formed continuously from the annular front peripheral portion to extend radially inward, and in which the wheel disc and the wheel rim are joined integrally with each other by welding the back surface portion of the wheel disc and an opening end portion of the front bead seat portion of the wheel rim to each other over the entire circumference of the automobile wheel without welding the annular back peripheral portion of the wheel disc and the wheel rim to each other. The back surface portion refers to a region on the back side of the wheel disc and inside the inner circumferential end of the annular back peripheral portion of the front flange portion.

In such a configuration, the front flange portion of the wheel disc is restrained by a portion where the wheel rim and the back surface portion of the wheel disc are welded to each other (which is hereinafter referred to as “welded portion”) on the annular front peripheral portion side whereas an inner peripheral end portion of the annular back peripheral portion is not restrained. Therefore, the load acting on the wheel rim and the load acting on the wheel disc via an axle act on the front flange portion via the welded portion and does not act directly on the annular back peripheral portion. Thus, stress concentration on a folded continuous portion between the annular back peripheral portion and the annular front peripheral portion caused by the loads can be mitigated. As a result, the folded continuous portion can have a sufficient stress allowance before reaching its durability limit, and has improved durability against a load acting thereon while the automobile is running.

In the automobile wheel discussed above, the front flange portion of the wheel disc may be formed such that the annular back peripheral portion thereof does not contact the wheel rim.

In such a configuration, because the annular back peripheral portion of the front flange portion and the wheel rim are not in contact with each other, the annular back peripheral portion receives no direct effect from the wheel rim. Therefore, a functional effect of the present invention discussed above, the mitigation of stress concentration on the folded continuous portion to improve the durability thereof, is further enhanced.

In the automobile wheel discussed above, the annular back peripheral portion of the front flange portion of the wheel disc may be in surface contact with a back surface of the annular front peripheral portion, and the annular front peripheral portion and the annular back peripheral portion may be integrally inclined to the surface side. The annular front peripheral portion and the annular back peripheral portion are inclined to the surface side with respect to an imaginary radial plane perpendicular to the center axis of the automobile wheel.

In such a configuration, because the annular front peripheral portion and the annular back peripheral portion of the front flange portion are in surface contact with each other, the folded continuous portion is less likely to be deformed by the loads generated while the automobile is running and stress concentration on the folded continuous portion can be mitigated. In addition, because the front flange portion in this configuration has a thickness which is substantially equal to the total thickness of the annular front peripheral portion and the annular back peripheral portion, the front flange portion has higher rigidity than the curved front flange portion according to the related art discussed above. This also helps to mitigate stress concentration on the folded continuous portion. The stress concentration on the folded continuous portion can be mitigated as described above, the durability improving effect discussed above is further enhanced.

In addition, the front flange portion, which is inclined to the surface side, exhibits excellent durability against a load acting radially thereon via a tire. Specifically, a load acts radially inwardly on the automobile wheel via a tire when the tire contacts a bump or curbstone while the automobile is running. Thus, the radially inward load directly acts on the front flange portion supporting a bead of the tire. The front flange portion of the present invention, which is inclined to the surface side, is easily elastically deformed to the surface side, in the direction in which it is inclined, by the radially inward load to prevent the load from acting on the central portion of the wheel disc. That is, the front flange portion in this configuration is effective in mitigating a radially inward load. In the case of an automobile wheel having a front flange portion extending radially (not inclined to the surface side), when a radially inward load acts thereon, the load tends to be transmitted to the central portion of the wheel disc because the front flange portion is less likely to undergo elastic deformation. In this case, stress concentration occurs at the joint between the axle and the automobile wheel and so on, increasing the possibility of a decrease in durability.

In addition, when the automobile runs onto a relatively large bump or a curbstone, a relatively strong load acts radially inwardly. Even in such a case, the configuration according to the present invention can mitigate the load by the forward elastic deformation of the front flange portion. On the other hand, in the case of an automobile wheel having a front flange portion extending radially as discussed above, because the load acts directly and locally on the front flange portion, the front flange portion tends to undergo local plastically deformation.

In the automobile wheel discussed above, a back surface of the annular front peripheral portion and a front surface of the annular back peripheral portion may not be in contact with each other with at least the annular front peripheral portion inclined to the surface side in the front flange portion of the wheel disc. In this configuration, the annular front peripheral portion is inclined to the surface side with respect to the radial imaginary plane discussed above. When the front flange portion is composed primarily of an annular front peripheral portion and an annular back peripheral portion, at least the annular front peripheral portion of the annular front peripheral portion and the annular back peripheral portion is inclined to the surface side.

In such a configuration, the annular front peripheral portion, which is formed continuously with the central portion of the wheel disc coupled to an axle and inclined to the surface side, can be elastically deformed to the surface side to mitigate a radially inward load acting thereon via a tire as described above. This improves durability and prevents the local plastic deformation as discussed above.

As discussed above, in the automobile wheel according to the present invention, a front flange portion including an annular front peripheral portion and an annular back peripheral portion is formed along an outer peripheral edge portion of a wheel disc, and a back surface portion and an opening end portion of a front bead seat portion of a wheel rim are circumferentially welded to each other without welding the annular back peripheral portion and the wheel rim to each other. Therefore, stress concentration on folded continuous portion of the front flange portion due to a load acting on the front flange portion via the wheel rim or the wheel disc while the automobile is running can be mitigated. The automobile wheel, therefore, has improved durability against a load generated while the automobile is running as a whole.

In the automobile wheel discussed above, when the front flange portion of the wheel disc is formed such that the annular back peripheral portion thereof does not contact the wheel rim, the annular back peripheral portion receives no direct effect from the wheel rim. Therefore, a functional effect of the present invention discussed above, the mitigation of stress concentration on the folded continuous portion to improve the durability thereof, is further enhanced.

In the automobile wheel discussed above, when the annular back peripheral portion of the front flange portion of the wheel disc is in surface contact with a back surface of the annular front peripheral portion and the annular front peripheral portion and the annular back peripheral portion are integrally inclined to the surface side, the front flange portion, which is inclined to the surface side, can be elastically deformed to mitigate a radially inward load generated by a contact of the tire with a bump or curbstone and acting on the front flange portion, improving, as a whole, the durability of the automobile wheel. Further, even when a relatively strong load is applied radially inwardly, the front flange portion elastically deforms to prevent itself from local plastic deformation. Therefore, the automobile wheel exhibits high durability against a load acting thereon radially inwardly via the front flange portion.

In the automobile wheel discussed above, when a back surface of the annular front peripheral portion and a front surface of the annular back peripheral portion are not in contact with each other with at least the annular front peripheral portion inclined to the surface side in the front flange portion of the wheel disc, the annular front peripheral portion can be elastically deformed to the surface side to mitigate a radially inward load acting thereon via a tire as described above. Therefore, improvement of durability and prevention of local plastic deformation can be achieved.

### BRIEF DESCRIPTION OF THE DRAWINGS

FIG. 1 is a vertical cross-sectional view of an automobile wheel 1 according to an example of the present invention.

FIG. 2 is an enlarged view of the part X of FIG. 1.

FIG. 3 is an explanatory view for comparison between (A) a front flange portion 31 in a first embodiment which is inclined to the surface side, and (B) a front flange portion 111 according to a comparative example which extends radially.

FIG. 4 is an enlarged vertical cross-sectional view illustrating a front flange portion 31 according to a modification of the example.

FIG. 5 is an enlarged vertical cross-sectional view illustrating a front flange portion 31 of an automobile wheel 51 according to another example.

FIG. 6 is an enlarged vertical cross-sectional view illustrating a front flange portion 61 of an automobile wheel 71 according to a further example.

FIG. 7 is an enlarged vertical cross-sectional view illustrating a front flange portion 71 according to a modification of the further example.

FIG. 8 is an enlarged vertical cross-sectional view illustrating a front flange portion 91 of an automobile wheel 81 according to an additional example.

FIG. 9 is an enlarged vertical cross-sectional view illustrating a front flange portion 91 according to a modification of the additional example.

FIG. 10 is a vertical cross-sectional view of an automobile wheel “m” according to the related art.

### DETAILED DESCRIPTION

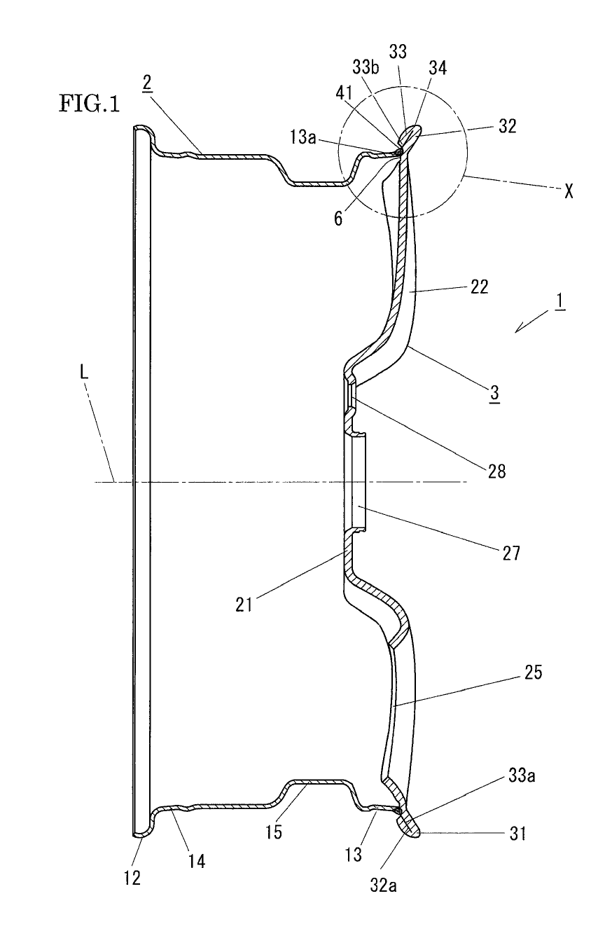

An automobile wheel 1 according the present invention will be described in detail with reference to the accompanying drawings. FIG. 1 is a vertical cross-sectional view of the automobile wheel 1 according to an example. The automobile wheel 1 is a so-called two-piece steel wheel formed by joining a wheel rim 2 and a wheel disc 3, each formed from a flat steel plate, to each other. The automobile wheel 1 has a full-face configuration in which a front flange portion 31 is provided at an outer peripheral edge portion of the wheel disc 3. In the first embodiment, the direction from the back surface side of the wheel disc 3 toward the design surface side (the direction from left to right in FIG. 1) is defined as a “forward direction”, and the opposite direction is defined as a “backward direction”. Also, the direction toward the center axis L of the automobile wheel 1 along the radial direction of the wheel is defined to as a “radially inward direction”, and the opposite direction is defined to as a “radially outward direction”. The design surface of the automobile wheel 1 or the wheel disc 3 refers to a surface which faces outward when the automobile wheel 1 is attached to an automobile.

The wheel rim 2 mentioned above is generally in the shape of a cylinder, and includes a back flange portion 12 provided at one (a back-side) opening edge portion to support a back bead of a tire. A back bead seat portion 14 on which the back bead of the tire is to be seated for support and fixation is formed continuously with the back flange portion 12. The wheel rim 2 further includes a front bead seat portion 13 which is provided at the other (a front) opening edge portion thereof and on which a front bead of the tire is to be seated for support and fixation. That is, no front flange portion 31 is formed at the other (front) opening edge portion of the wheel rim 2, and a front opening edge portion of the wheel rim 2 is formed by the annular front bead seat portion 13 extending along the front-back direction. The wheel rim 2 additionally includes a well portion 15 which is provided between the front and back bead seat portions 13 and 14 and into which the front and back beads of the tire are to be dropped to mount the tire.

The thus configured wheel rim 2 may be formed by abutting the short sides of a generally rectangular flat steel plate against each other and welding the short sides to each other to form a cylindrical member with a straight body, and then performing a so-called rolling process in which the cylindrical member is pressed by predetermined dies from both the inner and outer sides of the cylindrical member while it is rotated in the circumferential direction. The formation of the wheel rim 2 may be performed using a conventional formation method, and therefore is not described in detail herein.

Meanwhile, the wheel disc 3 mentioned above is generally in the shape of a disc, and includes a hub mounting portion 21 provided at the center to be coupled to a hub of an axle, and a front flange portion 31 provided circumferentially at an outer peripheral edge portion. The wheel disc 3 additionally includes a plurality of spoke portions 22 provided between and formed continuously with the hub mounting portion 21 and the front flange portion 31 and arranged at equal intervals in the circumferential direction to extend radially. Further, ornamental holes 25 are respectively formed between adjacent ones of the spoke portions 22.

A hub hole 27 is formed in the center of the hub mounting portion 21. A plurality of bolt holes 28 are formed radially outwardly of the hub hole 27 and arranged at equal intervals in the circumferential direction. The components of the wheel disc 3 are arranged concentrically around the center axis L of the wheel disc 3. The spoke portions 22 are formed to swell forward from the peripheral edge of the hub mounting portion 21. The front flange portion 31 is formed to be smoothly continuous from the outer end of each of the spoke portions 22. The front flange portion 31 constitutes a portion of the present invention, and will be discussed in detail later.

The thus configured wheel disc 3 may be formed by performing a pressing process on a generally circular flat steel plate. The formation of the wheel disc 3 may be performed using a conventional formation method, and therefore is not described in detail herein.

The automobile wheel 1 according to the example is formed by welding the wheel rim 2 and the wheel disc 3 discussed above to each other. The formation of the automobile wheel 1 constitutes a portion of the present invention, and will be discussed later.

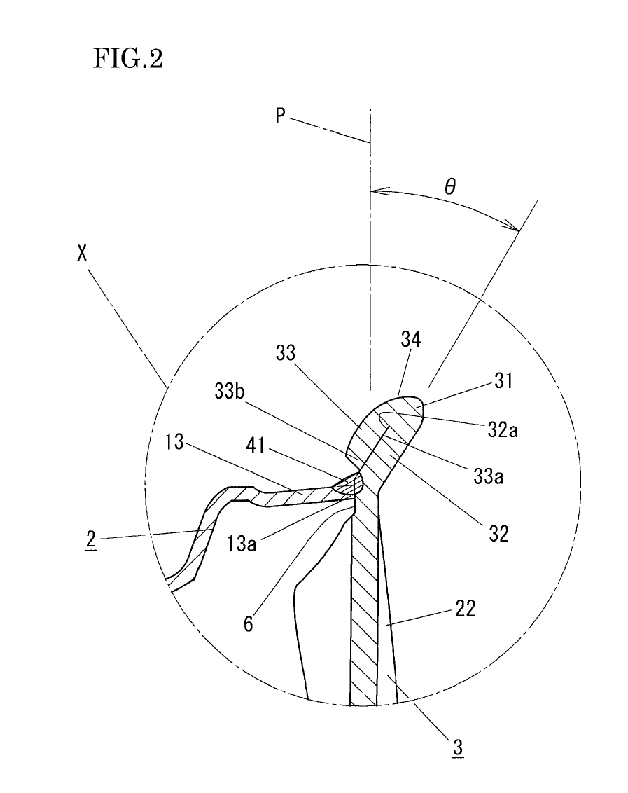

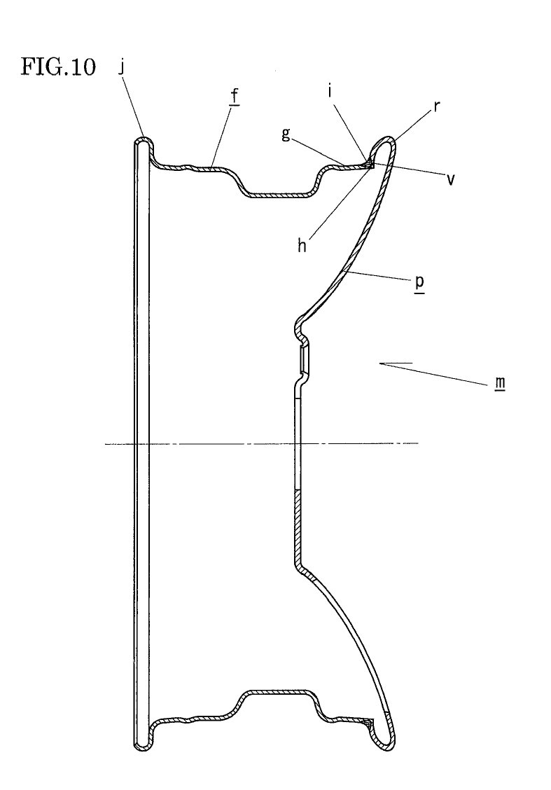

As shown in FIGS. 1 and 2, the front flange portion 31 provided along an outer peripheral edge portion of the wheel disc 3 is folded backward to extend radially inwardly. Specifically, the front flange portion 31 includes an annular front peripheral portion 32 provided on the design surface side and formed continuously from an outer end of each of the spoke portions 22, and an annular back peripheral portion 33 folded backward from the annular front peripheral portion 32 to extend radially inwardly. The annular back peripheral portion 33 and the annular front peripheral portion 32 are formed such that a front surface 33a of the annular back peripheral portion 33 is entirely in surface contact with a back surface 32a of the annular front peripheral portion 32. Therefore, the annular front peripheral portion 32 and the annular back peripheral portion 33 have a unitary construction to form the front flange portion 31. The front flange portion 31 has no gap between the annular front peripheral portion 32 and the annular back peripheral portion 33, which is the difference in configuration from the conventional configuration discussed above (see FIG. 10).

In addition, the front flange portion 31 is bent at the base end (inner peripheral end) of the annular front peripheral portion 32 and inclined to the surface side. That is, the front flange portion 31 is inclined at an inclination angle θ with respect to an imaginary radial plane P perpendicular to the center axis L of the automobile wheel 1 (plane extending in the radial direction). The inclination angle θ of the front flange portion 31 is set to an angle in the range of 15 degrees to 45 degrees inclusive. In a specific example, the inclination angle θ is 33 degrees.

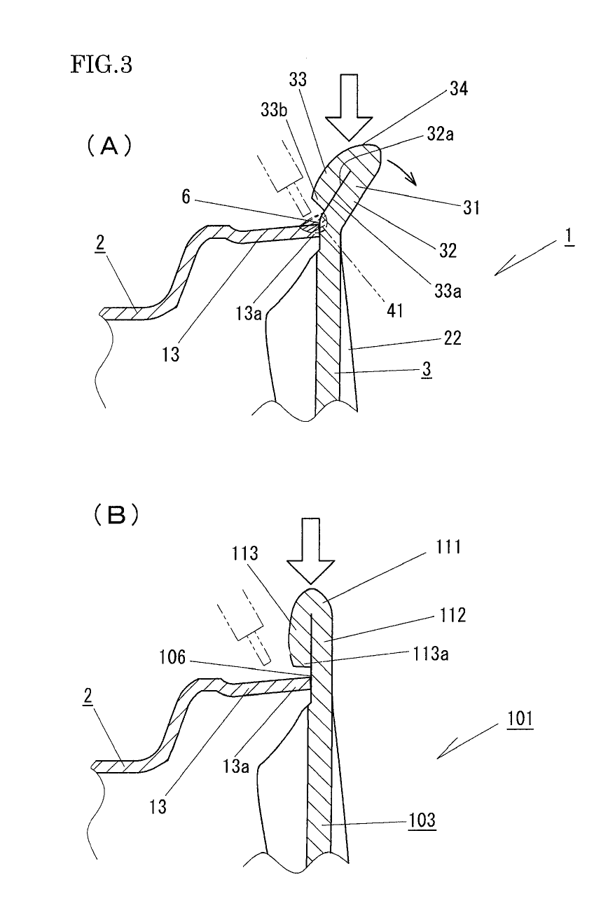

In the front flange portion 31, the innermost end (inner peripheral end portion 33b) of the annular back peripheral portion 33 is set to have an inside diameter which is greater than the outside diameter of an opening end portion 13a of the front bead seat portion 13 of the wheel rim 2. Thus, when the opening end portion 13a of the front bead seat portion 13 of the wheel rim 2 is in abutment with a back surface portion 6 of the wheel disc 3 (see FIG. 3(A)), the inner peripheral end portion 33b of the annular back peripheral portion 33 of the front flange portion 31 is located radially outside the opening end portion 13a of the front bead seat portion 13 and the inner peripheral end portion 33b and the opening end portion 13a does not contact each other as discussed later. In addition, the inside diameter of the inner peripheral end portion 33b of the annular back peripheral portion 33 of the front flange portion 31 and the outside diameter of the opening end portion 13a of the front bead seat portion 13 are set such that a prescribed gap is formed between the inner peripheral end portion 33b and the opening end portion 13a. Therefore, when the opening end portion 13a of the front bead seat portion 13 of the wheel rim 2 and the back surface portion 6 of the wheel disc 3 is welded to each other, the inner peripheral end portion 33b of the annular back peripheral portion 33 and the opening end portion 13a of the front bead seat portion 13 are prevented from being welded to each other.

A folded continuous portion 34 between the annular front peripheral portion 32 and the annular back peripheral portion 33 of the front flange portion 31 forms the outermost peripheral edge of the wheel disc 3.

Also, as shown in FIG. 2, in the wheel disc 3 according to the example, the back surface portion 6 having a back surface extending radially is formed annularly around the center axis L along the outer peripheral edge thereof except the front flange portion 31. That is, in this example, the back surface portion 6 is defined as an annular portion located inside the front flange portion 31 and adjacent to the front flange portion 31. In addition, the front flange portion 31 is formed continuously with each of the spoke portions 22 via the back surface portion 6. The back surface portion 6 has a planar back surface extending generally radially.

The wheel disc 3 and the wheel rim 2 are joined to each other by positioning the opening end portion 13a of the front bead seat portion 13 of the wheel rim 2 on the back surface portion 6 of the wheel disc 3 with the respective center axes L of the wheel disc 3 and the wheel rim 2 aligned with each other, and then welding the wheel disc 3 and the wheel rim 2 to each other. In this case, the back surface portion 6 of the wheel disc 3 and the opening end portion 13a of the front bead seat portion 13 of the wheel rim 2 are integrally joined to each other by arc-welding over the entire circumference of the automobile wheel 1 from outside of the wheel rim 2 (see FIG. 3(A)). As a result of the welding, as shown in FIG. 2, a welded portion 41 in which the wheel rim 2 and the wheel disc 3 are joined to each other is formed over the entire circumference of the automobile wheel 1. It should be noted that the annular back peripheral portion 33 of the front flange portion 31 is not welded to the annular front peripheral portion 32 or/and the back surface portion 6. As a result, the annular back peripheral portion 33 is formed continuously with the annular front peripheral portion 32 via the folded continuous portion 34 but the inner peripheral end portion 33b thereof is not restrained.

In the wheel disc 3, because the inner peripheral end portion 33b of the annular back peripheral portion 33 of the front flange portion 31 is located radially outside the outer surface of the front bead seat portion 13 of the wheel rim 2, and because the front flange portion 31 is inclined to the surface side, a groove-like gap (open gap) widened outwardly is circumferentially formed between the front bead seat portion 13 of the wheel rim 2 and the annular back peripheral portion 33 as shown in FIG. 3(A). Therefore, the opening end portion 13a of the front bead seat portion 13 and a back surface portion 6 can be welded to each other easily and stably because a welding torch can be inserted into the open gap to carry out the welding. In addition, because a welded portion 41 can be partially or entirely formed in the open gap, the welded portion 41 can be prevented from swelling outwardly. According to the configuration of this example, therefore, interference between a bead of a tire, which is mounted on the automobile wheel 1, and the welded portion 41 can be suppressed. Thus, the bead of the tire can be securely brought into tight contact with the front bead seat portion 13 of the wheel rim 2 and the front flange portion 31 of the wheel disc 3.

On the other hand, in the case of an automobile wheel 101 of a comparative example in which a front flange portion 111 of a wheel disc 103 extends radially (not inclined to the surface side), an inner peripheral end portion 113a of an annular back peripheral portion 113 faces an outer surface of the front bead seat portion 13 of the wheel rim 2 as shown in FIG. 3(B). Therefore, the width of the gap between the inner peripheral end portion 113a of the annular back peripheral portion 113 and the front bead seat portion 13 of the wheel rim 2 is narrower than that in the configuration of the first embodiment. In this case, the space for insertion of a welding torch is narrow, making it difficult to weld the front bead seat portion 13 and a back surface portion 106 to each other. In the configuration of the comparative example shown in FIG. 3(B), the annular back peripheral portion 113 of the front flange portion 111 is folded backward from an annular front peripheral portion 112 on the design surface side so that the annular back peripheral portion 113 can be in surface contact with the annular front peripheral portion 112.

Further, in the configuration shown in FIG. 3(A), the front flange portion 31, because of its inclined shape, easily deforms elastically in the inclined direction when a load is applied radially inwardly to the front flange portion 31 while the automobile is running. Because the radially inward load can be mitigated by the elastic deformation, the stress on the central portion (hub mounting portion 21) of the wheel disc 3 can be mitigated. Similarly, even when a relatively strong radially inward load is applied locally to the front flange portion 31, the load is mitigated by the elastic deformation. Therefore, the front flange portion 31 has improved durability against a radially inward load. On the other hand, in the configuration of the comparative example shown in FIG. 3(B), because the front flange portion 111 extends radially, stress on the central portion of the wheel disc 103 resulting from a radially inward load cannot be mitigated, in contrast to the configuration of the first embodiment. When the radially inward load is relatively strong, the front flange portion 111 may be plastically deformed locally. Thus, the front flange portion 31 in the configuration of this example has improved fatigue life compared to the front flange portion 111 in the configuration of the comparative example shown in FIG. 3(B).

As discussed above, in the automobile wheel 1 according to this example, the back surface portion 6 of the wheel disc 3 and the front bead seat portion 13 of the wheel rim 2 are welded to each other whereas the annular back peripheral portion 33 of the front flange portion 31 and the back surface portion 6 are not welded to each other and the annular back peripheral portion 33 of the front flange portion 31 and the front bead seat portion 13 of the wheel rim 2 are not welded to each other. In this configuration, the inner peripheral end portion 33b of the annular back peripheral portion 33 is not restrained, the load imposed on the wheel disc 3 via the axle and the load imposed on the wheel rim 2 via the tire while the vehicle is running are prevented from acting on the folded continuous portion 34 of the front flange portion 31. The stress concentration on the folded continuous portion 34 can be mitigated accordingly. Therefore, the folded continuous portion 34 of the front flange portion 31 can have a sufficient stress allowance before reaching its fatigue limit even in the case where a residual stress generated in the folded peripheral edge portion 34 of the front flange portion 31 during formation is left in the folded peripheral edge portion 34, improving the durability of the front flange portion 31.

In addition, the front flange portion 31 of the wheel disc 3 has a unitary structure in which the annular front peripheral portion 32 and the annular back peripheral portion 33 are in surface contact with each other. Therefore, stress concentration on the folded continuous portion 34 caused by a load acting via the wheel rim 2 or the wheel disc 3 can be mitigated more effectively.

The thus configured automobile wheel 1 according to the example can exhibit high durability compared to the automobile wheel “m” according to the related art discussed above (see FIG. 10). In the automobile wheel “m” according to the related art, the front flange portion “r” is folded into a curved shape, and the front flange portion “r” and the front bead seat portion “g” of the wheel rim “f” are welded to each other. Thus, the front flange portion “r” tends to be subjected to stress concentration due to loads generated while the automobile is running. In contrast, the configuration of the automobile wheel 1 of the present example can mitigate stress concentration on the front flange portion 31, improving the durability of the automobile wheel 1 compared to the automobile wheel “m” according to the related art.

Further, because the front flange portion 31 is inclined to the surface side, it is possible to weld the front bead seat portion 13 of the wheel rim 2 and the back surface portion 6 to each other easily and stably and to prevent the welded portion 41 from swelling outwardly. Moreover, even when a radially inward load that is generated by a contact of the automobile wheel 1 with a curbstone or the like while the automobile is running is applied to the front flange portion 31, the front flange portion 31 elastically deforms forwardly to mitigate the load. This improves the durability of the automobile wheel 1.

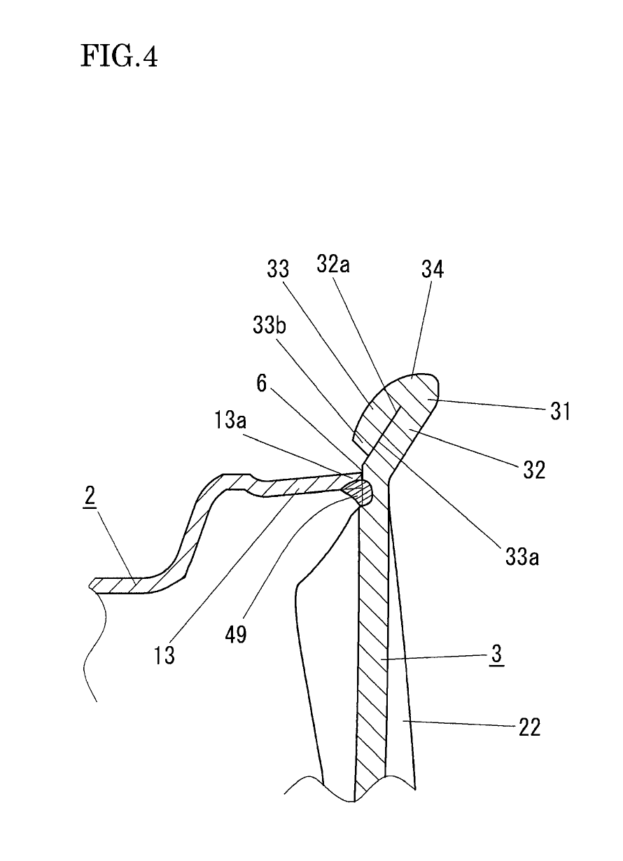

As a modification of the automobile wheel 1 according to the example discussed above, the opening end portion 13a of the front bead seat portion 13 of the wheel rim 2 and the back surface portion 6 of the wheel disc 3 may be welded to each other from inside of the wheel rim 2 as shown in FIG. 4. In such a configuration, a welded portion 49 is formed inside the front bead seat portion 13 of the wheel rim 2. The configuration of this modification can also mitigate stress concentration which occurs on the folded continuous portion 34 of the front flange portion 31 while the automobile is running and improve the durability of the folded continuous portion 34 just as the configuration according to the example discussed above. In addition, improvement of the durability against contact with a curbstone or the like and prevention of local plastic deformation can be also achieved.

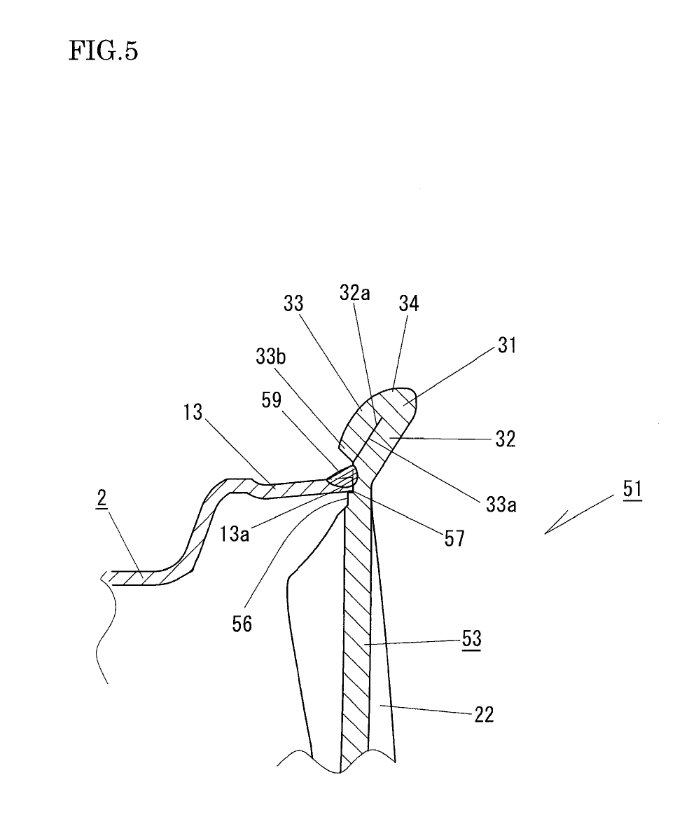

In an automobile wheel 51 according to another example, a wheel disc 53 includes a circumferential joint step portion 57 recessed forwardly in a step-like fashion in a back surface portion 56 along the outer peripheral edge except the front flange portion 31 as shown in FIG. 5. By engaging the opening end portion 13a of the front bead seat portion 13 of the wheel rim 2 with the circumferential joint step portion 57, the wheel rim 2 and the wheel disc 53 can be positioned with the respective center axes L thereof aligned with each other. Therefore, the wheel rim 2 and the wheel disc 53 can be positioned accurately and easily before welding. Also, in this example, a welded portion 59 joins the opening end portion 13a of the front bead seat portion 13 of the wheel rim 2 to the back surface portion 56 whereas the wheel rim 2 and the annular back peripheral portion 33 are not welded to each other.

This example is the same in configuration as the example discussed above except that the circumferential joint step portion 57 is provided. Thus, like constituent components are denoted by like reference numerals, and therefore are not described herein.

In the configuration according to this example, the front flange portion 31 that is the same as that in the example discussed above is provided, and the opening end portion 13a of the front bead seat portion 13 of the wheel rim 2 and the back surface portion 56 are welded to each other whereas the annular back peripheral portion 33 of the front flange portion 31 and the back surface portion 56 are not welded to each other. Thus, the configuration according to this example provides the same functional effects as the configuration according to the example discussed above.

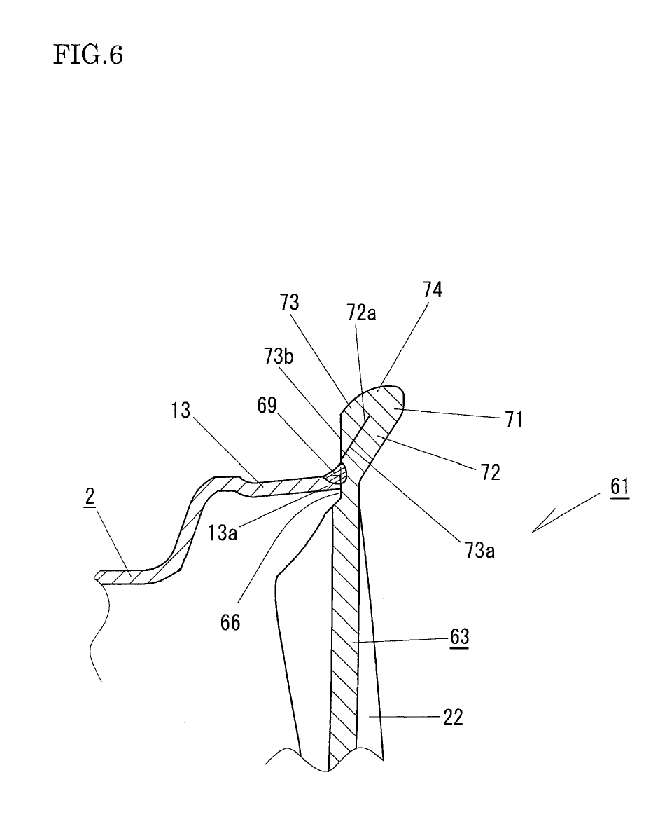

In an automobile wheel 61 according to a further example, an annular back peripheral portion 73 which forms a front flange portion 71 of a wheel disc 63 has an inner peripheral end surface 73b that is generally flush with a back surface portion 66 as shown in FIG. 6. An inner peripheral end surface 73b of the annular back peripheral portion 73 and the back surface of the back surface portion 66 both have a planar shape extending generally radially. The back surface portion 66 of the wheel disc 63 and the front bead seat portion 13 of the wheel rim 2 are welded to each other from outside.

In the front flange portion 71 of this example, an annular front peripheral portion 72 and the annular back peripheral portion 73 are integrally inclined to the surface side with a back surface 72a of the annular front peripheral portion 72 and a front surface 73a of the annular back peripheral portion 73 in surface contact with each other. The back surface portion 66 and the front bead seat portion 13 of the wheel rim 2 are welded to each other after the inner peripheral end surface 731b of the annular back peripheral portion 73 and the back surface portion 66 of the outer peripheral edge except the front flange portion 71 have been shaped to be generally flush with each other. That is, the front flange portion of this example is the same in configuration as the front flange portion in the above example except that the inner peripheral end surface 73b of the annular back peripheral portion 73 and the back surface portion 66 are shaped to be flush with each other. Thus, like constituent components are denoted by like reference numerals, and therefore are not described herein.

The configuration of this example can, just as the configuration of the example discussed above, mitigate the stress concentration on a folded continuous portion 74 of the front flange portion 71 caused by the load imposed on the wheel disc 63 via the axle and the load imposed on the wheel rim 2 via the tire while the automobile is running. Further, because the front flange portion 71 is inclined to the surface side, it is possible to weld the front bead seat portion 13 of the wheel rim 2 and the back surface portion 66 to each other easily and stably and to prevent the welded portion 69 from swelling outwardly. In addition, the front flange portion 71, which is inclined to the surface side, can prevent a radially inward load from acting on the central portion (hub mounting portion) of the wheel disc 63 and can be prevented from undergoing local plastic deformation.

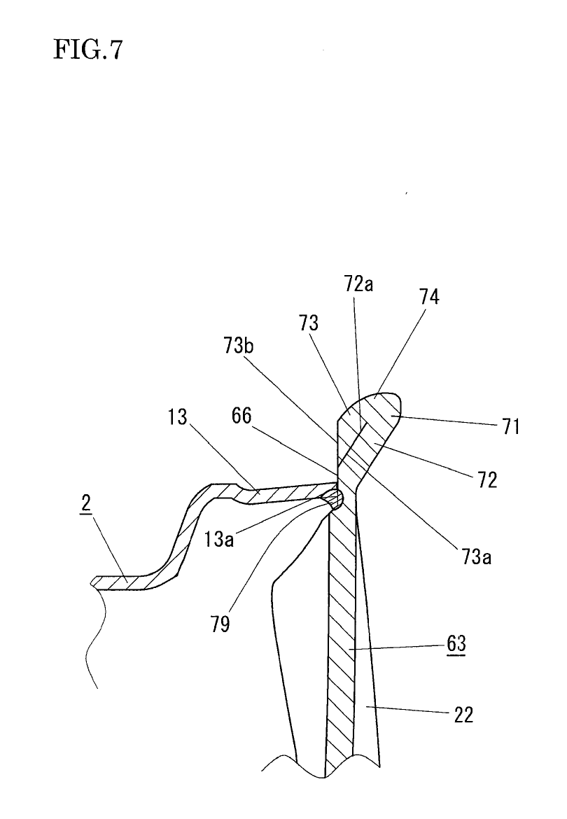

As a modification of the automobile wheel 61 according to the example discussed above, the opening end portion 13a of the front bead seat portion 13 of the wheel rim 2 and the back surface portion 66 of the wheel disc 63 may be welded to each other from inside of the wheel rim 2 as shown in FIG. 7. In such a configuration, a welded portion 79 is formed inside the front bead seat portion 13 of the wheel rim 2. The configuration of this modification can also provide the same functional effects as the example discussed above.

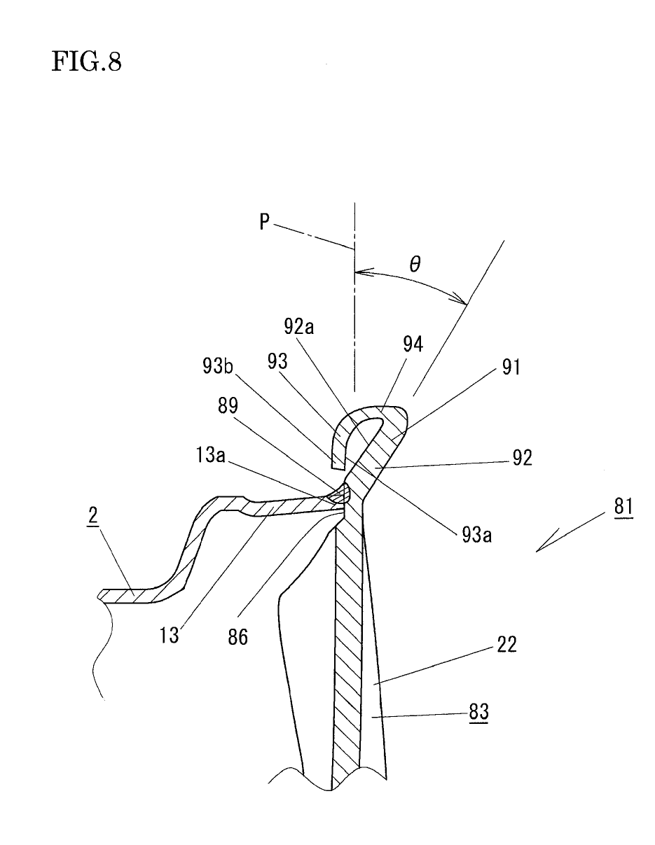

In an automobile wheel 81 according to yet another example, as shown in FIG. 8, a wheel disc 83 includes a front flange portion 91 provided at an outer peripheral edge portion and folded in a curved shape. The front flange portion 91 includes an annular front peripheral portion 92 provided on the design surface side, and an annular back peripheral portion 93 formed continuously from the annular front peripheral portion 92 and folded backward in a curved shape to extend radially inward. That is, a back surface 92a of the annular front peripheral portion 92 and a front surface 93a of the annular back peripheral portion 93 are not in surface contact with each other, and a hollow area is formed between the annular front peripheral portion 92 and the annular back peripheral portion 93.

The annular front peripheral portion 92 of the front flange portion 91 is inclined to the surface side with respect to a radial imaginary plane P. The inclination angle θ is set to an angle between 15 degrees and 45 degrees inclusive as in the example discussed above. In a specific example the inclination angle θ is 33 degrees. The annular back peripheral portion 93 has an inner peripheral end portion 93b with an inside diameter which is greater than the outside dimension of the front bead seat portion 13 of the wheel rim 2. Thus, the annular back peripheral portion 93 is not in contact with the front bead seat portion 13. In addition, in this example, the inner peripheral end portion 93b of the annular back peripheral portion 93 is formed not to contact the annular front peripheral portion 92 either. The inner peripheral end portion 93b of the annular back peripheral portion 93 of the thus configured front flange portion 91 is not restrained and is not in contact with the wheel rim 2 and the annular front peripheral portion 92. Therefore, because the load imposed via the wheel rim 2 and the load imposed via the central portion (hub mounting portion 21) of the wheel disc 83 while the automobile is running act on a folded continuous portion 94 via the annular front peripheral portion 92, stress concentration on the folded continuous portion 94 can be mitigated. In addition, because the annular front peripheral portion 92 is inclined to the surface side, even when a radially inward load is applied on contact with a curbstone or the like, the annular front peripheral portion 92 can be elastically deformed forwardly to mitigate the stress on the central portion (hub mounting portion 21) of the wheel disc 83. Similarly, even when a relatively strong radially inward load is applied locally, the load is mitigated by the elastic deformation and the annular front peripheral portion 92 can be prevented from undergoing local plastic deformation. Thus, the configuration according to the above example can also achieve the same durability improving effect as that achieved by the configuration according to the examples discussed above.

In the configuration according to this example, the inside diameter of the inner peripheral end portion 93b of the annular back peripheral portion 93 of the front flange portion 91 is set such that the inner peripheral end portion 93b and the front bead seat portion 13 of the wheel rim 2 are separated from each other by a prescribed distance. Therefore, the opening end portion 13a of the front bead seat portion 13 and a back surface portion 86 can be welded to each other easily and stably because a gap is formed between the annular back peripheral portion 93 and the front bead seat portion 13 and a welding torch can be inserted into the gap to carry out the welding from outside of the wheel rim 2. In addition, the gap prevents a welded portion 89 from swelling outwardly.

While the front flange portion 91 in this example is folded into a curved shape as described above, it can exhibit excellent durability against a load applied thereto while the automobile is running just as the front flange portion in the example discussed above. This example is the same in configuration as the example discussed above except that the front flange portion 91 of the wheel disc 83 is folded backward into a curved shape to define a hollow area therein. Thus, like constituent components are denoted by like reference numerals, and therefore are not described herein.

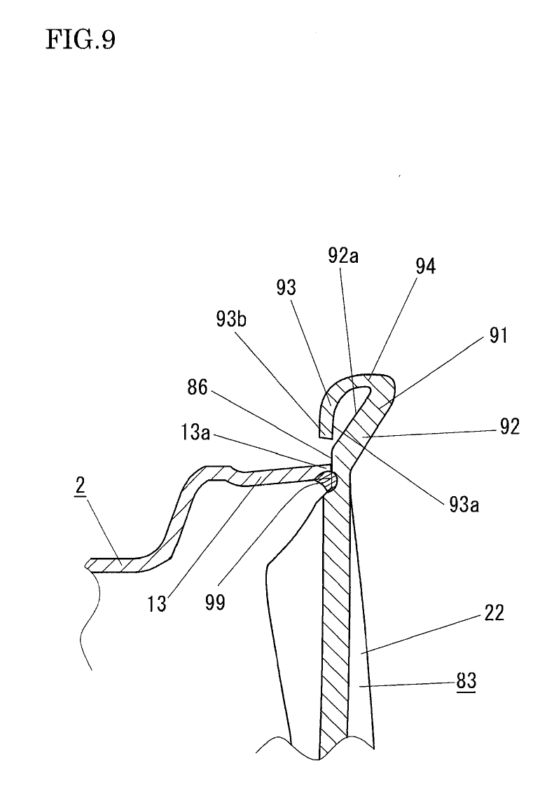

As a modification of the automobile wheel 81 according to the example discussed above, the opening end portion 13a of the front bead seat portion 13 of the wheel rim 2 and the back surface portion 86 of the wheel disc 83 may be welded to each other from inside of the wheel rim 2 as shown in FIG. 9. In such a configuration, a welded portion 99 is formed inside the front bead seat portion 13 of the wheel rim 2. The configuration of this modification can also provide the same functional effects as the example discussed above.

In each of the configurations according to the examples (and modifications of the embodiments) discussed above, an annular joint groove depressed to the surface side may be formed in the back surface portion so that the opening end portion of the front bead seat portion of the wheel rim can be seated and welded in the annular joint groove. In such a configuration, because the welded portion can be partially or entirely formed in the annular joint groove, the shape of the welded portion can be formed stably and the welded portion can be prevented from swelling outward more effectively.

In each of the configurations according to the example (and modifications of the example), a step-like circumferential joint step portion maybe formed in the back surface portion as in the above example. In this case, the wheel rim and the wheel disc can be positioned easily and accurately as in the other examples.

The present invention is not limited to above, and may be modified appropriately within the scope and spirit of the present invention. For example, the present invention may be applied to automobile wheels with the same configuration that are formed from an aluminum alloy, a magnesium alloy, a titanium alloy, or a fiber-reinforced metal (FRM), achieving the same effect.

What is claimed is:

1. An automobile wheel comprising:
a wheel rim comprising:
a back flange portion formed at one opening edge portion;
a front bead seat portion is formed at the other opening edge portion; and
a wheel disc in which a front flange portion is formed at an outer peripheral edge portion,
wherein the front flange portion of the wheel disc includes:
an annular front peripheral portion provided on a design surface side; and
an annular back peripheral portion folded backward from the annular front peripheral portion and formed continuously from the annular front peripheral portion to extend radially inward, and
wherein the wheel disc and the wheel rim are joined integrally with each other by welding the back surface portion of the wheel disc and an opening end portion of the front bead seat portion of the wheel rim to each other over the entire circumference of the automobile wheel without welding the annular back peripheral portion of the wheel disc and the wheel rim to each other.

2. The automobile wheel according to claim 1, wherein the front flange portion of the wheel disc is formed such that the annular back peripheral portion thereof does not contact the wheel rim.

3. The automobile wheel according to claim 1, wherein the annular back peripheral portion of the front flange portion of the wheel disc is in surface contact with a back surface of the annular front peripheral portion, and the annular front peripheral portion and the annular back peripheral portion are integrally inclined to the surface side.

4. The automobile wheel according to claim 1, wherein a back surface of the annular front peripheral portion and a front surface of the annular back peripheral portion may not be in contact with each other with at least the annular front peripheral portion inclined to the surface side in the front flange portion of the wheel disc.
